(19) United States
(12) Patent Application Publication
(10) Pub. No.: US 2015/0256815 A1
(43) Pub. Date: Sep. 10, 2015

(54) 3D CAMERA CALIBRATION

(71) Applicant: TELEFONAKTIEBOLAGET L M ERICSSON (PUBL), Stockholm (SE)

(72) Inventor: Beatriz Grafulla-González, Solna (SE)

(73) Assignee: TELEFONAKTIEBOLAGET L M ERICSSON (PUBL), Stockholm (SE)

(21) Appl. No.: 14/431,864

(22) PCT Filed: Oct. 1, 2012
(86) PCT No.: PCT/EP2012/069353

§ 371 Date: Mar. 27, 2015

(51) Int. Cl. H04N 13/02; G06T 7/00; G06F 3/01; G06T 17/00; G06F 3/041; G06F 3/0481

(52) U.S. Cl. CPC H04N 13/0246; G06F 3/0412; G06F 3/04815; G06F 3/011; G06T 17/00; G06T 7/0018; G06T 2207/10004; G06T 2207/30196

(57) ABSTRACT

There is provided a 3D camera calibration wherein the user's hand is used as a calibration object: a touch surface detects the real measurements of a user's hand; the 3D camera captures at least one image of the user's hand; and an image processor estimates the intrinsic and extrinsic parameters for calibrating the 3D camera based on said image and said real measurements.

### TECHNICAL FIELD

The present application relates to a method for calibrating a 3D camera, an apparatus for capturing 3D images, and a computer-readable medium.

### BACKGROUND

A 3D camera is able to capture a three dimensional (3D) scene such that a 3D representation of the scene can be displayed at an appropriate display apparatus. A 3D camera may comprise, for example, a stereo camera or a texture plus depth camera.

When using a 3D camera one needs initially to calibrate it. This means that one needs to estimate the camera parameters (i.e. its extrinsic and intrinsic parameters) in order to carry out the registration of the two images obtained.

These could be either two textures or the combination of one texture and one depth map. Image registration is required for the correct alignment of the two images, this is necessary to allow a correct 3D experience to be delivered at a 3D display apparatus.

The camera parameter estimation is typically performed with the help of a calibration panel 100, which is illustrated in FIG. 1. Calibration panel 100 comprises a resilient sheet material 110 carrying a calibration pattern 120. Calibration pattern 120 comprises a black and white chessboard pattern. More complicated patterns are sometimes used. In general, a calibration pattern comprises a high contrast black and white pattern to assist in signal processing and calculation.

A particular 3D camera will have a particular calibration panel associated with it. This is necessary so that the physical dimensions of the panel are known to the camera. Using a similar patterned panel with a different scale would give an inaccurate calibration of the camera. When the camera images its own calibration panel, it can derive actual physical distances from the image. Based on these real distances, the camera parameters are estimated.

Alternatively, a 3D camera can be calibrated automatically from the information in the images without a calibration panel. This is done by matching points that represent the same scene location from the two images and then estimating the camera parameters. Unfortunately, this method, although convenient, is limited as no absolute values of the camera are determined. Indeed, the scene distances in reality are unknown so there is not sufficient information for full calibration. In other words, a fundamental problem with automatic parameter estimation is the lack of scale information from the scene, preventing the estimation of absolute camera parameter values. Further, camera calibration without a calibration panel is far more computationally demanding than calibration with a calibration panel.

A problem with the calibration panel solution is that the calibration panel is not always available. In general, this panel is big (typically A4 or A3 size) and one does not carry it around. Also, the calibration software is adapted to a unique size of the panel, which means that other calibration panels having similar patterns but with different measurements can not be used instead.

There is provided herein a solution to the problem of camera calibration when there is a lack of prior information available, that is, when an appropriate calibration panel is not available.

### SUMMARY

The methods described herein are aimed at devices that incorporate touch surfaces. Such devices may use touchable screens, as contemporary tablets and smartphones do. A device can obtain a good estimate of the size and the form of a body part such as a user's hand by detecting it when applied to the touch surface. Once this is done, the hand can be used as a calibration object by detecting salient features (e.g. the fingers tips), which are then used to estimate the camera parameters. The calibration can be improved by using a pose estimation algorithm to determine an arrangement of the user's hand from the image(s).

Accordingly, there is provided a method for calibrating a 3D camera. The method comprises detecting measurements of a user's body part on a touch surface, and capturing at least one image of the user's body part with the 3D camera. The method further comprises applying the detected measurements to the at least one image to estimate parameters of the 3D camera.

Using the above method, no specific calibration panel is required and yet absolute camera parameter values can be determined. As a consequence, camera calibration becomes an easy task for an average user, and can be performed without specialist equipment.

The application of the detected measurements to the at least one image may comprise applying the measurements to a model template to generate a 3D model of the user's body part, and fitting the 3D model to the at least one image. The fitting may be done using a pose estimation algorithm, or a segmentation algorithm.

The parameters of the 3D camera may be intrinsic and/or extrinsic parameters. The extrinsic parameters (sometimes called external parameters) may comprise at least one of: orientation, rotation, location, or translation of the camera. The intrinsic parameters (sometimes called internal parameters) may comprise at least one of: pixel size, pixel skew, or focal length.

The estimation of parameters of the 3D camera may comprise: estimating a camera projection matrix; and recovering intrinsic and extrinsic parameters from the projection matrix. The method may further comprise refining the recovered intrinsic and extrinsic parameters using nonlinear optimization.

The body part may be a hand. The body part may be bigger than the touch surface, and the detecting measurements of a user's body part may comprise multiple detections each of different sections of the body part. The method may further comprise obtaining a measurement of the complete body part from a composite of the multiple detections.

There is further provided an apparatus for capturing 3D images, the apparatus comprising a touch surface, a 3D camera and an image processor. The touch surface is for detecting measurements of a user's body part. The 3D camera is arranged to capture at least one image of the user's body part. The image processor is arranged to apply the detected measurements to the at least one image and to estimate parameters of the 3D camera, the parameters for calibrating the 3D camera.

Using the above apparatus, no specific calibration panel is required and yet absolute camera parameter values can be determined. As a consequence, camera calibration becomes an easy task for an average user, and can be performed without specialist equipment. The 3D camera may be arranged to capture a plurality of images of the user's body part.

The image processor may be further arranged to apply the measurements of a user's body part to a template body part model to generate a 3D model of the user's body part; and to fit the 3D model to the at least one image of the user's body part. The fitting may be done using a pose estimation algorithm.

The parameters of the 3D camera may be intrinsic and/or extrinsic parameters. The extrinsic parameters (sometimes called external parameters) may comprise at least one of: orientation, rotation, location, or translation of the camera. The intrinsic parameters (sometimes called internal parameters) of the camera comprise at least one of: pixel size, pixel skew, or focal length.

The estimation of parameters of the 3D camera may comprise: estimating the camera projection matrix, and recovering intrinsic and extrinsic parameters from the projection matrix.

The touch surface may be a touch screen. The apparatus may be a tablet computer or smartphone. The touch surface may be a handle or part of a casing of the apparatus. The body part may be a hand.

There is further provided a computer-readable medium, carrying instructions, which, when executed by computer logic, causes said computer logic to carry out any of the methods defined herein.

There is further provided a computer-readable storage medium, storing instructions, which, when executed by computer logic, causes said computer logic to carry out any of the methods defined herein. The computer program product may be in the form of a non-volatile memory or volatile memory, e.g. an EEPROM (Electrically Erasable Programmable Read-only Memory), a flash memory, a disk drive or a RAM (Random-access memory).

### BRIEF DESCRIPTION OF THE DRAWINGS

A method and apparatus for 3D camera calibration will now be described, by way of example only, with reference to the accompanying drawings, in which:

FIG. 1 illustrates a calibration panel used for 3D camera calibration;

FIG. 2 illustrates the geometry of a 2D camera;

FIG. 3 illustrates a basic method for calibrating a 3D camera;

FIG. 4 illustrates the method for calibrating a 3D camera in more detail;

FIG. 5 shows an example of a generic model of a human hand;

FIG. 6 illustrates another method for calibrating a 3D camera; and

FIG. 7 illustrates an apparatus suitable for implementing the methods disclosed herein.

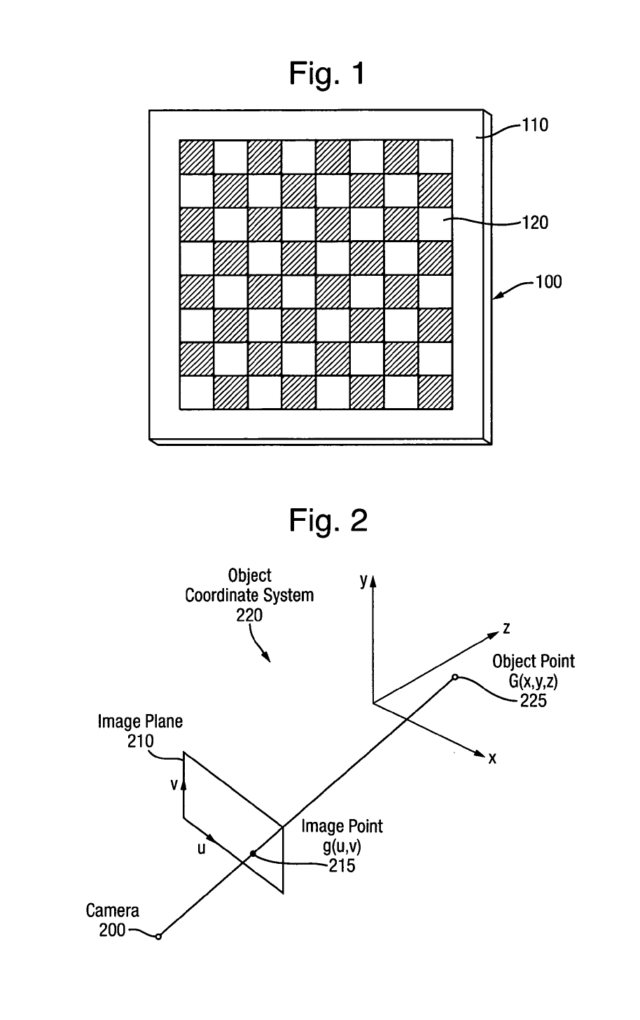

### DETAILED DESCRIPTION

FIG. 2 illustrates a simple one camera setup, which would comprise a part of a 3D camera (e.g. one half of a stereo camera). The camera is illustrated as a point 200 and has an image plane 210. Objects exist in an object coordinate system X, Y, Z 220. An image point g (u, v) 215 on the image plane 210 corresponds to an object point G (X, Y, Z) 225. The image point 215 is defined by where a ray drawn from an object point 225 going to the camera 200 intersects the image plane 210. The image plane coordinates u, v take into account camera pixel size and skew, which are parameters intrinsic to the camera. The distance of the object coordinate system 220 from the camera 200 and the angle between these are examples of parameters extrinsic to the camera.

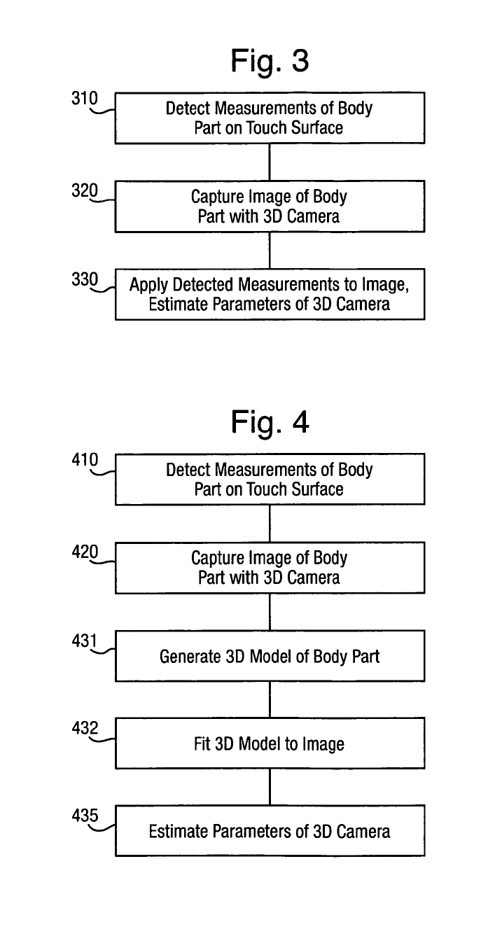

FIG. 3 illustrates a basic method for calibrating a 3D camera. The method comprises detecting 310 measurements of a user's body part as it is applied to a touch sensitive surface. The method further comprises capturing 320 an image of the user's body part with the 3D camera. The method further comprises applying 330 the detected measurements to the image of the user's body part to estimate parameters of the 3D camera.

In the examples herein we consider the user's hand as the body part used for 3D camera calibration, but it should be noted that any other object or parts of the body could be used provided that it can be sensed by the touch sensitive surface.

The user is initially requested to place her/his hand over the touch sensitive surface. The touch sensitive surface may be a touch screen or a touch sensitive surface incorporated into a carrying handle of the device. The device determines the area of the surface that is covered by the hand. Since the physical size of the surface is fixed, and known to the device, the size of the hand can be determined. The measurements taken from the touch surface may comprise the length of the fingers, the width of the palm, etc. These measurements are applied to a generic human hand model to generate a 3D model of the user's hand. In embodiments where another part of the user's body is used for camera calibration, a generic model of that part of a human body is used. The user may be given a choice as to which body part to use for camera calibration. At least one generic model of a body part is stored in the device.

Then, the user is requested to show the hand in front of the 3D camera with different distances to the camera and different hand poses. The arrangement and pose of the hand can be determined from a camera view using a segmentation algorithm, or pose estimation algorithm.

Of course, the hand may show a different pose to the one detected by the touch sensitive surface. Even if the user intends to show the same pose, the pose may not be the same shape as when pressed against the touch sensitive surface, for example the fingers may not have the same separation. As a result, the size of the hand in the picture is calculated and its pose is also estimated using the 3D model of the user's hand. With this information, the distances in the picture are deduced.

The salient features of the hand (e.g. finger tips) are detected in the camera image and the camera parameters are estimated with the deduced information.

FIG. 4 illustrates the method for calibrating a 3D camera in more detail. The method comprises detecting 410 measurements of a user's body part as it is applied to a touch sensitive surface. The method further comprises capturing 420 an image of the user's body part with the 3D camera. The method further comprises generating 431 a 3D model of the body part applied to the touch sensitive surface, and fitting 432 this 3D model to an image of the user's body part as captured by the 3D camera. The method further still comprises estimating 435 parameters of the 3D camera.

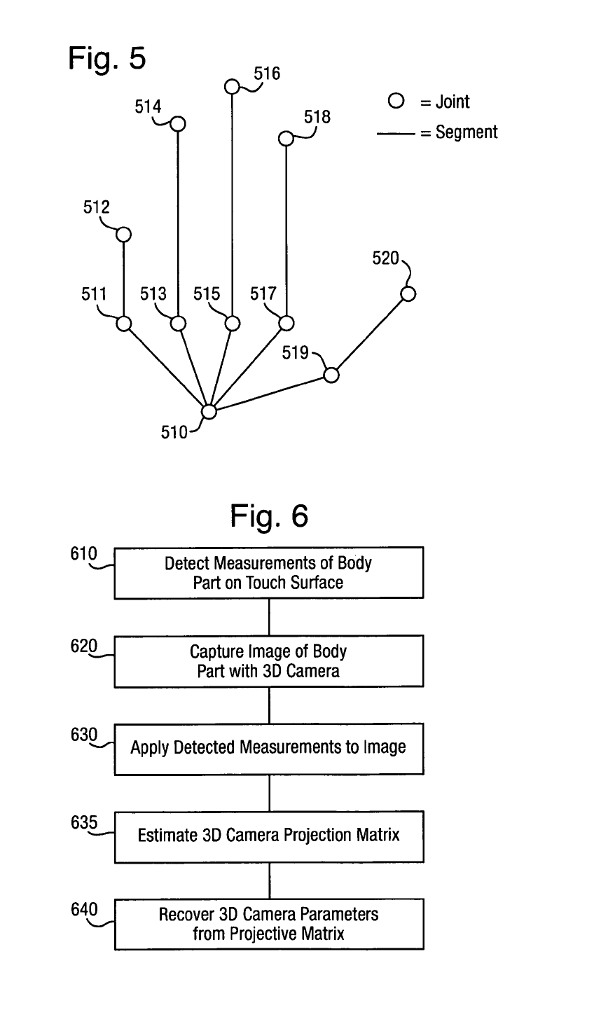

FIG. 5 shows an example of a generic model of a human hand. This is a basic model which does not include all degrees of freedom of the human hand. However, this model would be suitable for use with a substantially flat touch sensitive surface and where the user is instructed to present a flat hand to the 3D camera for calibration. Other embodiments use more detailed generic models.

The model comprises a plurality of joints 510 to 520, connected by segments. This is a 3D model, meaning that the segments may be moved around the joints in a 3D space. To create such a model of the user's hand, the length of the segments is determined from the measurements taken by the touch sensitive surface.

This model of the user's hand is then fit to an image from the 3D camera. In computer vision, there are methods and techniques to fit deformable models with a 2D image of a 3D scene. One example is “Human body pose estimation with particle swarm optimisation” by Ivekovic S, Trucco E, Petillot Y R, and published in Evolutionary Computation, 2008 Winter; 16(4):509-28, the human body pose estimation method described in this paper is incorporated herein by reference.

Once the model is fitted to the image, one knows the location of each joint of the user's hand in each calibration image (in as many images are needed to perform the calibration). Where the 3D camera comprises two 2D cameras, simultaneous images from each camera are taken of the hand in a pose, and the same pose is fit to each view, but rotated to allow for the slightly different perspective of each camera. With this information, the required camera parameters can be determined.

FIG. 6 illustrates another method for calibrating a 3D camera, this method including more detail about the calibration of the 3D camera. The method comprises detecting 610 measurements of a user's body part as it is applied to a touch sensitive surface. The method further comprises capturing 620 an image of the user's body part with the 3D camera. The method further comprises applying 630 the detected measurements to the image of the user's body part.

With reference to FIG. 2, a 3D camera projection matrix defines the relationship between the coordinates of an object point 225 in the object coordinate system 220, and the coordinates of the image point 215 in the image plane 210. The camera projection matrix is defined by the intrinsic and extrinsic parameters of the 3D camera. With the use of the user's hand as a calibration object, the camera projection matrix can be estimated 635. With enough different views of the user's hand, the intrinsic and extrinsic parameters of the camera can be derived, and the calibration completed.

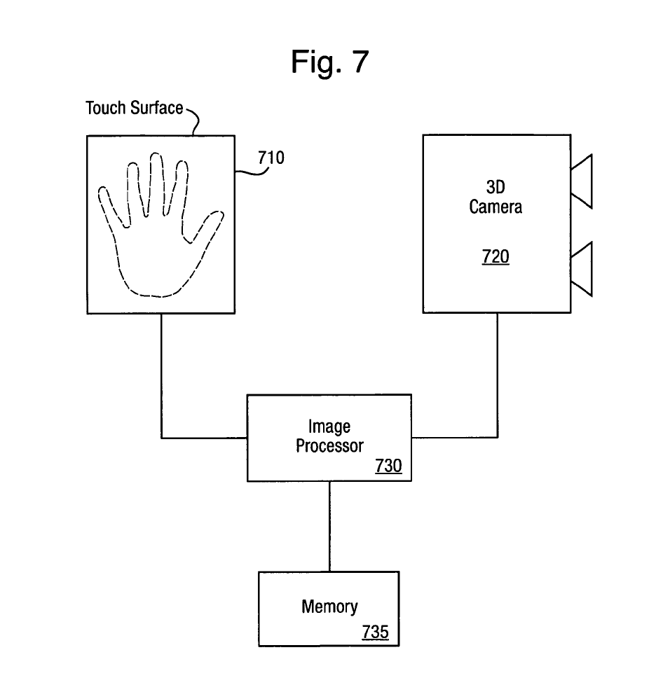

FIG. 7 illustrates an apparatus suitable for implementing the above described methods. The apparatus comprises a touch sensitive surface 710, a 3D camera 720, and an image processor 730, and a memory 735.

The touch sensitive surface 710 is arranged to detect measurements of a user's body part, such as their hand. The 3D camera 720 is arranged to capture an image of the user's body part. The image processor 730 is arranged to apply the detected measurements to the image of the user's body part and to estimate parameters of the 3D camera, the parameters for calibrating the 3D camera.

The image processor 730 is arranged to receive instructions which, when executed, cause the processor 730 to carry out the above described method. The instructions may be stored on the memory 735.

An advantage of this solution is that no specific calibration panel is required and still absolute camera parameter values can be estimated. Likewise, different calibration panels may be used. As a consequence, camera calibration becomes an easy task for an average user, and can be performed without specialist equipment, and moreover with an item that the majority of users always have two of available to them.

The solution described herein is particularly applicable to tablet computers having 3D cameras built in. But this solution could be used with a touch surface smaller than the user's hand if multiple overlapping impressions of a user's hand are taken to allow the device to piece together a composite impression of the user's hand.

It may also be noted that such devices are typically calibrated upon manufacture. However, camera sensors may move (e.g. during transportation), and sooner or later a new calibration is required. Only a minor disturbance to the original setup is required to result in a 3D effect which is uncomfortable to a viewer of the captured 3D scene. As such, having a easily performed calibration process could be very useful.

It will be apparent to the skilled person that the exact order and content of the actions carried out in the method described herein may be altered according to the requirements of a particular set of execution parameters. Accordingly, the order in which actions are described and/or claimed is not to be construed as a strict limitation on order in which actions are to be performed.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfill the functions of several units recited in the claims. Any reference signs in the claims shall not be construed so as to limit their scope.

1. A method for calibrating a 3D camera, the method comprising:
detecting measurements of a user's body part on a touch surface;
capturing at least one image of the user's body part with the 3D camera;
applying the detected measurements to the at least one image to estimate parameters of the 3D camera.

2. The method of claim 1, wherein the application of the detected measurements to the at least one image comprises:
applying the measurements to a model template to generate a 3D model of the user's body part; and
fitting the 3D model to the at least one image.

3. The method of claim 1, wherein the parameters of the 3D camera are one or more of intrinsic and extrinsic parameters.

4. The method of claim 1, wherein the estimation of parameters of the 3D camera comprises:
estimating a camera projection matrix; and
recovering intrinsic and extrinsic parameters from the projection matrix.

5. The method of claim 4, further comprising refining the recovered intrinsic and extrinsic parameters using nonlinear optimization.

6. The method of claim 1, wherein the body part is a hand.

7. The method of claim 1, wherein the body part is bigger than the touch surface, and the detecting measurements of a user's body part comprises multiple detections each of different sections of the body part.

8. An apparatus for capturing 3D images, the apparatus comprising:
a touch surface for detecting measurements of a user's body part;
a 3D camera arranged to capture at least one image of the user's body part; and
an image processor arranged to apply the detected measurements to the at least one image and to estimate parameters of the 3D camera, the parameters for calibrating the 3D camera.

9. The apparatus of claim 8, wherein the image processor is arranged to apply the measurements of a user's body part to a model template to generate a 3D model of the user's body part; and to fit the 3D model to the at least one image of the user's body part.

10. The apparatus of claim 8, wherein the parameters of the 3D camera are one or more of intrinsic and extrinsic parameters.

11. The apparatus of claim 8, wherein the estimation of parameters of the 3D camera comprises:
estimating the camera projection matrix, and
recovering intrinsic and extrinsic parameters from the projection matrix.

12. The apparatus of claim 8, wherein the touch surface is a touch screen.

13. The apparatus of claim 12, wherein the apparatus is a tablet or smartphone.

14. The apparatus of claim 8, wherein the touch surface is a handle or part of a casing of the apparatus.

15. The apparatus of claim 8, wherein the body part is a hand.

16. A non-transitory computer-readable medium, carrying instructions, which, when executed by computer logic, causes said computer logic to carry the method defined by claim 1.
